(19) United States
(12) Patent Application Publication
(10) Pub. No.: US 2025/0344210 A1
(43) Pub. Date: Nov. 6, 2025

(54) COMBINED DOWNLINK CONTROL INFORMATION AND DOWNLINK SHARED CHANNEL COMMUNICATED IN A SINGLE TIME RESOURCE

(71) Applicant: QUALCOMM Incorporated, San Diego, CA (US)

(72) Inventors: Morteza SOLTANI, San Diego, CA (US); Jing SUN, San Diego, CA (US)

(21) Appl. No.: 18/653,544

(22) Filed: May 2, 2024

(51) Int. Cl. H04W 72/1273; H04W 72/0446; H04W 72/232; H04W 72/30

(52) U.S. Cl. CPC H04W 72/1273; H04W 72/0446; H04W 72/232; H04W 72/30

(57) ABSTRACT

Methods, systems, and devices for wireless communications are described. A user equipment (UE) receives a first control message scheduling downlink shared channel resource allocation types for processing in a single time resource, where the downlink shared channel resource allocation types include one or more of unicast downlink control information (DCI) carried over a downlink shared channel, unicast downlink shared channel data carried over the downlink shared channel, or unicast DCI modulated with downlink data transmissions carried over the downlink shared channel. The UE receives a second control message indicating additional control information for one or more of the plurality of downlink shared channel resource allocation types. The UE processes the multiple downlink shared channel resource allocation types within the single time resource. The UE may communicate with a network entity based at least in part on the plurality of downlink shared channel resource allocation types.

### FIELD OF TECHNOLOGY

The following relates to wireless communications, including combined downlink control information and downlink shared channel communicated in a single time resource.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, a network entity may output downlink control information (DCI) to a UE, for example, indicating a resource allocation (e.g., time and/or frequency resources) for a downlink grant for downlink communications from the network entity to the UE and/or an uplink grant for uplink communications from the UE to the network entity. The DCIs may be transmitted over a physical downlink control channel (PDCCH). A UE may monitor a control resource set (CORESET) and perform blind decoding on various DCI candidates to identify the DCI intended for the UE.

### SUMMARY

The systems, methods, and devices of this disclosure each have several innovative aspects, no single one of which is solely responsible for the desirable attributes disclosed herein.

The described techniques relate to improved methods, systems, devices, and apparatuses that support combining downlink control information (DCI) and downlink shared channel in a single time resource. To reduce blind decoding of various DCIs (e.g., including DCI candidates or DCI intended for other user equipments (UEs)) and to increase DCI processing efficiency, the UE may receive a first control message scheduling multiple downlink shared channel resource allocation types for processing in a single time resource. The multiple downlink shared channel resource allocation types may include one or more of unicast downlink control information carried over a downlink shared channel, unicast downlink shared channel data carried over the downlink shared channel, or unicast downlink control information modulated with downlink data transmissions carried over the downlink shared channel. The UE may receive a second control message indicating additional control information for one or more of the multiple downlink shared channel resource allocation types. The UE may process the multiple downlink shared channel resource allocation types within the single time resource. The UE may communicate with a network entity based on the multiple downlink shared channel resource allocation types.

A method for wireless communications by a UE is described. The method may include receiving a first control message scheduling a set of multiple downlink shared channel resource allocation types for processing in a single time resource, where the set of multiple downlink shared channel resource allocation types include one or more of unicast DCI carried over a downlink shared channel, unicast downlink shared channel data carried over the downlink shared channel, or unicast DCI modulated with downlink data transmissions carried over the downlink shared channel, receiving a second control message indicating additional control information for one or more of the set of multiple downlink shared channel resource allocation types, processing the set of multiple downlink shared channel resource allocation types within the single time resource, and communicating with a network entity based on the set of multiple downlink shared channel resource allocation types.

A UE for wireless communications is described. The UE may include one or more memories storing processor executable code, and one or more processors coupled with the one or more memories. The one or more processors may individually or collectively be operable to execute the code to cause the UE to receive a first control message scheduling a set of multiple downlink shared channel resource allocation types for processing in a single time resource, where the set of multiple downlink shared channel resource allocation types include one or more of unicast DCI carried over a downlink shared channel, unicast downlink shared channel data carried over the downlink shared channel, or unicast DCI modulated with downlink data transmissions carried over the downlink shared channel, receive a second control message indicating additional control information for one or more of the set of multiple downlink shared channel resource allocation types, process the set of multiple downlink shared channel resource allocation types within the single time resource, and communicate with a network entity based on the set of multiple downlink shared channel resource allocation types.

Another UE for wireless communications is described. The UE may include means for receiving a first control message scheduling a set of multiple downlink shared channel resource allocation types for processing in a single time resource, where the set of multiple downlink shared channel resource allocation types include one or more of unicast DCI carried over a downlink shared channel, unicast downlink shared channel data carried over the downlink shared channel, or unicast DCI modulated with downlink data transmissions carried over the downlink shared channel, means for receiving a second control message indicating additional control information for one or more of the set of multiple downlink shared channel resource allocation types, means for processing the set of multiple downlink shared channel resource allocation types within the single time resource, and means for communicating with a network entity based on the set of multiple downlink shared channel resource allocation types.

A non-transitory computer-readable medium storing code for wireless communications is described. The code may include instructions executable by one or more processors to receive a first control message scheduling a set of multiple downlink shared channel resource allocation types for processing in a single time resource, where the set of multiple downlink shared channel resource allocation types include one or more of unicast DCI carried over a downlink shared channel, unicast downlink shared channel data carried over the downlink shared channel, or unicast DCI modulated with downlink data transmissions carried over the downlink shared channel, receive a second control message indicating additional control information for one or more of the set of multiple downlink shared channel resource allocation types, process the set of multiple downlink shared channel resource allocation types within the single time resource, and communicate with a network entity based on the set of multiple downlink shared channel resource allocation types.

In some examples of the method, UEs, and non-transitory computer-readable medium described herein, receiving the second control message may include operations, features, means, or instructions for communicating a message indicating a capability of the UE to support processing of the set of multiple downlink shared channel resource allocation types in the single time resource and receiving the second control message based on the capability.

In some examples of the method, UEs, and non-transitory computer-readable medium described herein, communicating the message indicating the capability may include operations, features, means, or instructions for communicating radio resource control signaling including the message indicating the capability.

In some examples of the method, UEs, and non-transitory computer-readable medium described herein, the second control message includes a first format of DCI carried over a downlink control channel or a DCI component carried over one of the set of multiple downlink shared channel resource allocation types.

In some examples of the method, UEs, and non-transitory computer-readable medium described herein, the additional control information includes a set of multiple DCI parameters corresponding to respective downlink shared channel resource allocations types and the UE uses the set of multiple DCI parameters for the processing.

In some examples of the method, UEs, and non-transitory computer-readable medium described herein, the set of multiple downlink shared channel resource allocation types includes at least one multicast DCI and the UE may be capable of processing the set of multiple downlink shared channel resource allocation types based on a threshold quantity of different downlink shared channel resource allocation types the UE may be capable of processing within the single time resource.

In some examples of the method, UEs, and non-transitory computer-readable medium described herein, in response to the multiple downlink shared channel resource allocation types exceeding the threshold quantity of different downlink shared channel resource allocation types the UE is capable of processing within the single time resource, and the multiple downlink shared channel resource allocation types including the at least one multicast DCI, the method, apparatuses, and non-transitory computer-readable medium may include further operations, features, means, or instructions for prioritizing a unicast DCI over the at least one multicast DCI for processing the set of multiple downlink shared channel resource allocation types.

Some examples of the method, UEs, and non-transitory computer-readable medium described herein may further include operations, features, means, or instructions for storing the at least one multicast DCI in a buffer for subsequent processing based on the prioritizing.

Some examples of the method, UEs, and non-transitory computer-readable medium described herein may further include operations, features, means, or instructions for receiving a message, prior to processing, indicating that the set of multiple downlink shared channel resource allocation types include the at least one multicast DCI.

In some examples of the method, UEs, and non-transitory computer-readable medium described herein, the single time resource includes a slot.

A method for wireless communications by a network entity is described. The method may include outputting a first control message scheduling a set of multiple downlink shared channel resource allocation types for processing by a UE in a single time resource, where the set of multiple downlink shared channel resource allocation types include one or more of unicast DCI carried over a downlink shared channel, unicast downlink shared channel data carried over the downlink shared channel, or unicast DCI modulated with downlink data transmissions carried over the downlink shared channel, outputting a second control message indicating additional control information for one or more of the set of multiple downlink shared channel resource allocation types, and communicating with the UE based on the UE processing the set of multiple downlink shared channel resource allocation types within the single time resource.

A network entity for wireless communications is described. The network entity may include one or more memories storing processor executable code, and one or more processors coupled with the one or more memories. The one or more processors may individually or collectively be operable to execute the code to cause the network entity to output a first control message scheduling a set of multiple downlink shared channel resource allocation types for processing by a UE in a single time resource, where the set of multiple downlink shared channel resource allocation types include one or more of unicast DCI carried over a downlink shared channel, unicast downlink shared channel data carried over the downlink shared channel, or unicast DCI modulated with downlink data transmissions carried over the downlink shared channel, output a second control message indicating additional control information for one or more of the set of multiple downlink shared channel resource allocation types, and communicate with the UE based on the UE processing the set of multiple downlink shared channel resource allocation types within the single time resource.

Another network entity for wireless communications is described. The network entity may include means for outputting a first control message scheduling a set of multiple downlink shared channel resource allocation types for processing by a UE in a single time resource, where the set of multiple downlink shared channel resource allocation types include one or more of unicast DCI carried over a downlink shared channel, unicast downlink shared channel data carried over the downlink shared channel, or unicast DCI modulated with downlink data transmissions carried over the downlink shared channel, means for outputting a second control message indicating additional control information for one or more of the set of multiple downlink shared channel resource allocation types, and means for communicating with the UE based on the UE processing the set of multiple downlink shared channel resource allocation types within the single time resource.

A non-transitory computer-readable medium storing code for wireless communications is described. The code may include instructions executable by one or more processors to output a first control message scheduling a set of multiple downlink shared channel resource allocation types for processing by a UE in a single time resource, where the set of multiple downlink shared channel resource allocation types include one or more of unicast DCI carried over a downlink shared channel, unicast downlink shared channel data carried over the downlink shared channel, or unicast DCI modulated with downlink data transmissions carried over the downlink shared channel, output a second control message indicating additional control information for one or more of the set of multiple downlink shared channel resource allocation types, and communicate with the UE based on the UE processing the set of multiple downlink shared channel resource allocation types within the single time resource.

In some examples of the method, network entities, and non-transitory computer-readable medium described herein, outputting the second control message may include operations, features, means, or instructions for receiving a message indicating a capability of the UE to support processing of the set of multiple downlink shared channel resource allocation types in the single time resource and outputting the second control message based on the capability.

In some examples of the method, network entities, and non-transitory computer-readable medium described herein, receiving the message indicating the capability may include operations, features, means, or instructions for receiving radio resource control signaling including the message indicating the capability.

In some examples of the method, network entities, and non-transitory computer-readable medium described herein, the second control message includes a first format of DCI carried over a downlink control channel or a DCI component carried over one of the set of multiple downlink shared channel resource allocation types.

In some examples of the method, network entities, and non-transitory computer-readable medium described herein, the additional control information includes a set of multiple DCI parameters corresponding to respective downlink shared channel resource allocations types.

In some examples of the method, network entities, and non-transitory computer-readable medium described herein, the set of multiple downlink shared channel resource allocation types includes at least one multicast DCI.

In some examples of the method, network entities, and non-transitory computer-readable medium described herein, in response to the set of multiple downlink shared channel resource allocation types exceeding a threshold quantity of different downlink shared channel resource allocation types the UE may be capable of processing within a single time resource, and the set of multiple downlink shared channel resource allocation types including the at least one multicast DCI, a unicast DCI may be prioritized over the at least one multicast DCI.

Some examples of the method, network entities, and non-transitory computer-readable medium described herein may further include operations, features, means, or instructions for outputting a message, prior to the UE processing, indicating that the set of multiple downlink shared channel resource allocation types include the at least one multicast DCI.

In some examples of the method, network entities, and non-transitory computer-readable medium described herein, the single time resource includes a slot.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports combined downlink control information and downlink shared channel communicated in a single time resource in accordance with one or more aspects of the present disclosure.

FIG. 2 shows an example of a wireless communications system that supports combined downlink control information and downlink shared channel communicated in a single time resource in accordance with one or more aspects of the present disclosure.

FIG. 3 shows an example of a process flow that supports combined downlink control information and downlink shared channel communicated in a single time resource in accordance with one or more aspects of the present disclosure.

FIGS. 4 and 5 show block diagrams of devices that support combined downlink control information and downlink shared channel communicated in a single time resource in accordance with one or more aspects of the present disclosure.

FIG. 6 shows a block diagram of a communications manager that supports combined downlink control information and downlink shared channel communicated in a single time resource in accordance with one or more aspects of the present disclosure.

FIG. 7 shows a diagram of a system including a device that supports combined downlink control information and downlink shared channel communicated in a single time resource in accordance with one or more aspects of the present disclosure.

FIGS. 8 and 9 show block diagrams of devices that support combined downlink control information and downlink shared channel communicated in a single time resource in accordance with one or more aspects of the present disclosure.

FIG. 10 shows a block diagram of a communications manager that supports combined downlink control information and downlink shared channel communicated in a single time resource in accordance with one or more aspects of the present disclosure.

FIG. 11 shows a diagram of a system including a device that supports combined downlink control information and downlink shared channel communicated in a single time resource in accordance with one or more aspects of the present disclosure.

FIGS. 12 through 14 show flowcharts illustrating methods that support combined downlink control information and downlink shared channel communicated in a single time resource in accordance with one or more aspects of the present disclosure.

### DETAILED DESCRIPTION

In some wireless communications systems, a network entity may output downlink control information (DCI) to a user equipment (UE), for example, indicating a resource allocation (e.g., time and/or frequency resources) for a downlink grant for downlink communications from the network entity to the UE and/or an uplink grant for uplink communications from the UE to the network entity. The DCIs may be transmitted over a physical downlink control channel (PDCCH). A UE may monitor a control resource set (CORESET) and perform blind decoding on various DCI candidates to identify the DCI intended for the UE. However, blind decoding for multiple candidates may result in processing inefficiencies at the UE.

To reduce blind decoding of the DCIs communicated over the PDCCH and to increase DCI processing efficiency, the DCI may be transmitted over a physical downlink shared channel (PDSCH) or combined with PDSCH messages. In particular, a first portion of DCI (e.g., DCI1) may be provided over PDCCH (e.g., indicating resource allocation) and a second portion of DCI (e.g., DCI2) may be provided over or combined with the PDSCH (e.g., uplink grant and/or downlink grant). In some examples, the UE may process (e.g., due to limitations based on configuration or processing limitations) a single PDSCH per time resource (e.g., slot). However, processing a single PDSCH may result in inefficient processing at the UE based on the combination of the DCI and PDSCH in the time resource.

To efficiently process PDSCH in a time resource, the network entity may configure the UE with different combination of PDSCH resource allocation types including a unicast DCI that is carried over a PDSCH (e.g., DCI only), a unicast PDSCH (e.g., PDSCH only), and/or a unicast DCI modulated with downlink data transmissions carried over the PDSCH (e.g., unicast DCI “piggyback” or combined with PDSCH). In some examples, the combination may be signaled on DCI1 carried over PDCCH or on any of the DCI components carried over PDSCH. In some examples, the UE may indicate a capability of processing a quantity of different PDSCHs (e.g., in a time resource) that may be signaling via radio resource control (RRC) signaling. The UE may use knowledge of the combination type (e.g., the PDSCH resource allocation type) since each PDSCH may be associated with respective transport block calculations and/or different decoding schemes) the combination type information may be used to efficiently process PDSCHs in a single time a resource (e.g., within the span of a single slot).

Aspects of the disclosure are initially described in the context of wireless communications systems. Aspects of the disclosure are further illustrated by and described with reference to apparatus diagrams, system diagrams, and flowcharts that relate to combined DCI and downlink shared channel communicated in a single time resource.

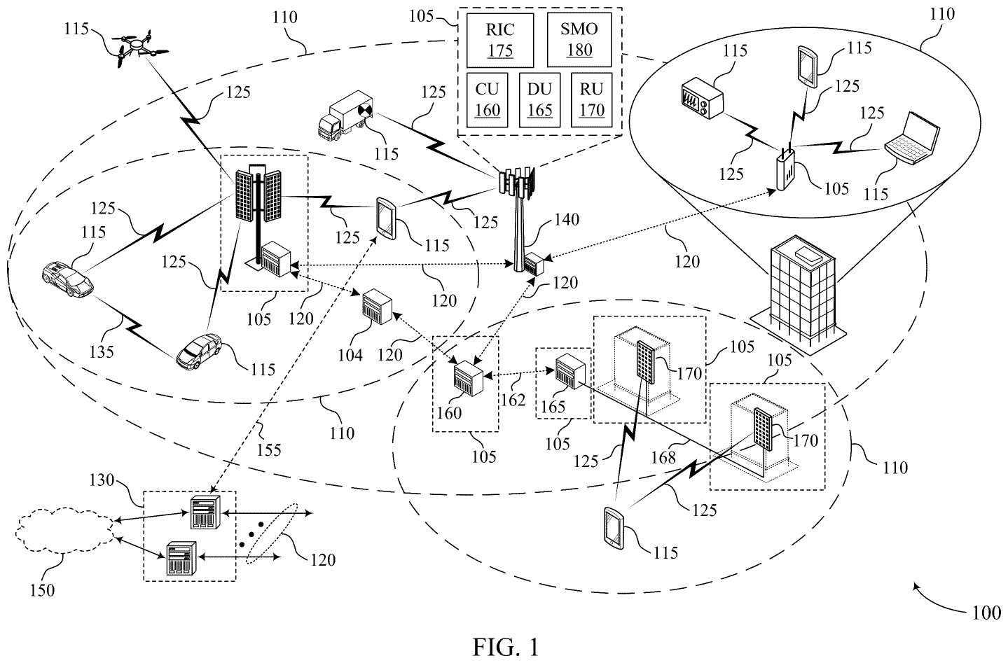

FIG. 1 shows an example of a wireless communications system 100 that supports combined DCI and downlink shared channel communicated in a single time resource in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., Nr) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples, a network entity 105 of the wireless communications system 100 may output DCI to the UE 115, for example, indicating a resource allocation (e.g., time and/or frequency resources) for a downlink grant for downlink communications from the network entity 105 to the UE 115 and/or an uplink grant for uplink communications from the UE 115 to the network entity 105. The DCIs may be transmitted over a PDCCH. A UE may monitor a CORESET and perform blind decoding on various DCI candidates to identify the DCI intended for the UE 115. However, blind decoding for multiple candidates may result in processing inefficiencies at the UE 115.

To reduce blind decoding of the DCIs communicated over the PDCCH and to increase DCI processing efficiency, the DCI may be combined with a PDSCH. In particular, a first portion of DCI (e.g., DCI1) may be provided over PDCCH (e.g., indicating resource allocation) and a second portion of DCI (e.g., DCI2) may be provided over or combined with the PDSCH (e.g., uplink grant and/or downlink grant). In some examples, the UE may process a single PDSCH per time resource (e.g., slot). However, processing a single PDSCH may result in inefficient processing at the UE 115 based on the combination of the DCI and PDSCH in the time resource.

To efficiently process PDSCH in a time resource, the network entity 105 may configure the UE 115 with different combination of PDSCH resource allocation types including a unicast DCI carried over a PDSCH, a unicast PDSCH, and/or a unicast DCI modulated with downlink data transmissions carried over the PDSCH (e.g., unicast DCI “piggyback” PDSCH). In some examples, the combination may be signaled on DCI1 carried over PDCCH or on any DCI component carried over PDSCH. In some examples, the UE 115 may indicate a capability of processing a quantity of different PDSCHs (e.g., in a time resource) that may be signaling via RRC signaling. The UE 115 may use knowledge of the combination type (e.g., the PDSCH resource allocation type) since each PDSCH may be associated with respective transport block calculations and/or different decoding schemes) the combination type information may be used to efficiently process PDSCHs in a single time a resource.

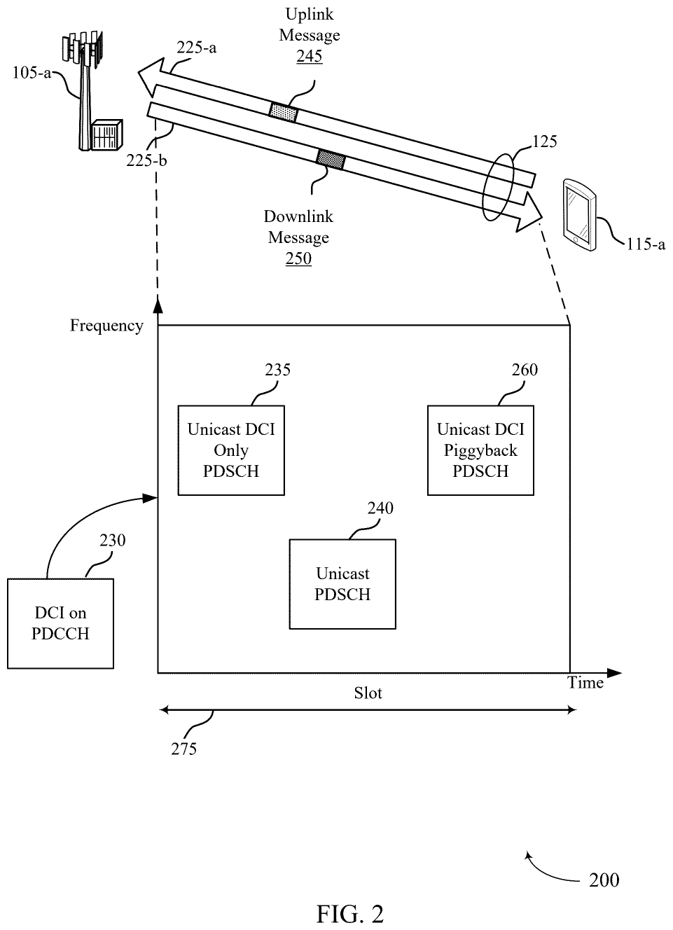

FIG. 2 shows an example of a wireless communications system 200 that supports combined DCI and downlink shared channel communicated in a single time resource in accordance with one or more aspects of the present disclosure. The wireless communications system 200 may implement aspects of or may be implemented by aspects of the wireless communications system 100. For example, the wireless communications system 200 includes a UE 115-a and a network entity 105-a, which may be examples of a UE 115 and a network entity 105 described with respect to FIG. 1.

In some wireless communication systems 200, such as a new radio (NR) communication systems, DCI may be used for multiple reasons, such as for a downlink grant, an uplink grant, and the link. The DCI may be transferred over PDCCH delivered in the CORESET, and the UE 115-a may perform blind decoding of many decoding candidates in the CORESET to identify the DCI targeting the UE 115-a. The blind decoding candidates may be organized in search space sets and one or more search space sets may be associated with one CORESET. An NR PDCCH blind decoding may operate or correspond to a PDCCH blind decoding in an LTE wireless communication system, for example, for when many UEs 115 are to be served with PDCCH at the same time. The NR PDCCH blind decoding may reduce signal blocking (e.g., signaled DCI) between UEs 115 to randomly hash locations of PDCCH from different UEs 115 differently in the CORESET. In such examples, analog beamforming and the resource allocation may be notable differences between 4G PDCCH and 5G PDCCH. In some examples, blind decoding may result in a non-negligible processing burden and thus higher complexity for UE 115. To reduce blind decoding of PDCCH and enhance DCI transmission efficiency, the DCI may be combined with PDSCH (e.g., piggybacked). Combining the DCI with PDSCH may offload control from the PDCCH region, reducing the blind decoding otherwise used for the PDCCH. The size of DCI in PDCCH may be kept to a minimum.

Offloading from the PDCCH region may also reserve PDCCH resources for other UEs 115, such as those without a downlink grant. The DCI combined with PDSCH may also increase efficiency for controlled delivery, for example, by reducing cyclic redundancy check (CRC) or overhead for aggregating multiple DCIs. The CRC length may be reduced, further reducing clipping. Controlled delivery may also include demodulation reference signals (DMRS) sharing with data DMRS. Beamforming and rank efficiency (e.g., rules) may facilitate reusing data rate control for control, possibly with a backoff for higher reliability compared to data, due to lack of retransmission for control. For the offloading, the offload variable length part of DCI to DCI2 (piggybacked on PDSCH) may more easily align to the size for DCI1 (carried over PDCCH) portion across multiple formats. Accordingly, the UE 115-a may reduce blind decoding.

The DCI may be delivered in two parts. The first part (i.e., DCI1) may be carried over PDCCH, indicating information about PDSCH including resource allocation, rank, and modulation order for processing the subsequent DCIs. Delivering the DCI in two parts enables the DMRS based channel estimation and demodulation. The first part of the DCI may also provide a field to provide information about the combined part of the DCI (e.g., DCI2) including size (e.g., quantity of resource elements), code rate (e.g., payload size), time domain resource allocation (TDRA) of the second DCI, frequency domain resource allocation (FDRA) of the second DCI, and rank of the second DCI. The first part of the DCI may also contribute to a rate control for the second part DCI (e.g., DCI2).

The second part of the DCI (i.e., DCI2), may be carried over PDSCH. The remaining second portion of the DCI may be related to the DL grant information (e.g., HARQ (e.g., HARQ process identifier (ID), redundancy version (RVID), new data indicator (NDI), and other non-time critical information such as transmit power control (TPC), channel state information (CSI) triggering, sounding reference signaling (SRS) triggering, downlink assignment index (DAI), and so forth.) The second portion of the DCI may include other DCIs, such as an UL grant (e.g., frequency division duplex (FDD) or time division duplex (TDD) with the UL grant for a later slot). The second portion of the DCI may include other downlink grants, such as grants for later slots for multi-slot transmission time interval (TTI) multi slot grants. The second part may include other downlink grants, such as the downlink grants for later slots for multi-TTI or multi-slot grants.

In a unicast mode, the UE-specific control information may be transferred to the UE 115-a. After the UE 115-a blindly decodes a unicast DCI1 on PDCCH using its cell radio network temporary identifier (C-RNTI), the UE ID field may not be signaled in DCI2 carried over PDSCH. The first portion of DCI (e.g., DCI1 on PDCCH associated with search space set and COREST may be decoded by the UE 115-a.

In the broadcast or multicast mode, the network entity 105-a may group UEs 115-a using DCI1 in PDCCH and includes the corresponding UE-specific control information for each UE 115-a in DCI2 carried over PDSCH. For example, the network entity 105-a may wish to send multiple downlink grants and uplink grants to multiple UEs 115, wherein each UE 115 is configured with a downlink grant or an uplink grant. The network entity 105-a may use DCI1 on PDCCH to first address a group of UEs 115 and then use PDSCH to transfer each UE's specific DCI. The PDSCH may be received by all groups of the UEs 115-a.

In some examples, the network entity 105-a may transmit many DCIs to the same UE 115-a and there may not be enough space for the PDSCH data anymore (i.e., DCI piggybacked on PDSCH without a downlink shared channel). Also, in case the PDSCH payload size is not considering combined DCI (e.g., piggyback combined DCI), the impact to PDSCH decoding might be too high. For example, the first portion of DCI in unicast, DCI1 on PDCCH, may be associated with a search space set and a CORESET that is to be decoded by the UE 115-a. For broadcast or multicast, the first portion of the DCI, DCI1 on PDCCH, may be associated with a search space set and a CORESET that is to be decoded by all the UE 115-a.

In some examples, when DCI is carried over a PDSCH (either a portion of PDSCH is allocated to the DCI or entire PDSCH is allocated to the DCI), the PDSCH may be treated differently than another PDSCH. For example, with combined DCI, the combined DCI on PDSCH (e.g., piggyback on PDSCH), may impact transport block sizes and transport block calculations. In current 5G NR systems and with unicast DCI, up to 2 transport blocks per slot may be processed and decoded by the UE 115-a. For example, one transport block per PDSCH per slot up to rank 4 may be decoded and above rank 4, 2 transport blocks per PDSCH per slot may be decoded.

For some wireless systems (e.g., 6G and the like), more than one transport block may be scheduled per PDSCH per slot (e.g., even for ranks less than 4), and the UE 115-a may be capable of decoding multiple PDSCHs (e.g., one transport block per PDSCH) per slot.

In such examples, if the UE 115-a is capable of processing multiple PDSCHs per slot, the network entity 105-a may configure multiple PDSCHs (e.g., multiple downlink shared channel resource allocation types) per slot for the UE 115-a to process. For example, a network entity 105-a may configure a UE 115-a with one PDSCH (e.g., a downlink shared channel resource allocation type including only downlink shared channel, no DCI), one DCI only PDSCH (a downlink shared channel resource allocation type including only DCI, and no downlink shared channel), and one DCI combined on PDSCH (a downlink shared channel resource allocation type including both DCI and downlink shared channel data messages) depending on how many different PDSCHs a UE 115-a may process per slot. Therefore, a signaling mechanism may be used to support all the possible configurations of the transmission of different PDSCH types.

In the wireless communications system 200, to support all the possible configurations, the network entity 105-a may communicate with the UE 115-a using a communication link 125. In some examples, the communication link 125 may include a first channel 225-a for transmitting data from the UE 115-a to the network entity 105-a and a second channel 225-b for transmitting data from the network entity 105-a to the UE 115-a. The communication link 125 may be an example of an NR or LTE link between the UE 115-a and the network entity 105-a. The communication link 125 may include a bi-directional link that enables both uplink and downlink communications, for example, via the channels 225. For example, the UE 115-a may transmit uplink messages 245 (e.g., uplink transmissions), such as uplink control signals or uplink data signals, to the network entity 105-a using the first channel 225-a (e.g., of the communication link 125) and the network entity 105-a may transmit downlink messages 250 (e.g., downlink transmissions), such as downlink control signals or downlink data signals, to the UE 115-a using the second channel 225-b (e.g., of the communication link 125). In some examples, the downlink messages 250 may be part of control signaling transmitted from the network entity 105-a.

The network entity 105-a may transmit, via a downlink message 250, a DCI on PDCCH 230 used to schedule PDSCHs. Different PDSCH types may be scheduled at a single slot 275 (e.g., time resource). In some examples, the UE 115-a may transmit, via an uplink message 245, an indication of a capability of the UE 115-a to support the various types of PDSCHs (e.g., different downlink shared channel resource allocation types) and/or a quantity of PDSCHs. Accordingly, the network entity 105-a may output the PDSCHs based on the received capability. For example, the based on the capability, the network entity 105-a may output a unicast DCI only PDSCH 235 (e.g., DCI only, no PDSCH), a unicast PDSCH 240 (e.g., no DCI, only PDSCH), and/or a unicast DCI combined with PDSCH 260 (e.g., DCI piggyback PDSCH, both DCI and PDSCH). The different types of PDSCHs may be associated with different processing transport blocks, impacting the quantity of PDSCHs and/or types that the UE 115-a is capable of processing at the slot 275.

For example, in a unicast mode and provided that a UE 115-a is capable of processing N different PDSCHs (each PDSCH with maybe 1 transport block) per downlink slot 275, the network entity 105-a may configure the UE 115-a with different combinations of “Unicast DCI only PDSCH”, “Unicast PDSCH”, and “Unicast DCI Piggyback PDSCH” and signal those combinations to the unicast DCI only PDSCH 235, the unicast PDSCH 240, and the unicast DCI combined with PDSCH 260. If the UE 115-a is capable of processing three different PDSCH types of combinations per downlink slot, the network entity 105-a may configure a combination of the unicast DCI only PDSCH 235, the unicast PDSCH 240, and/or the unicast DCI combined with PDSCH 260, and signal it to the UE 115-a.

In some examples, the combination may be signaled on DCI1 carried over PDCCH or on any of the DCI components carried over PDSCH. In some examples, the UE 115-a capability of processing N different PDSCHs may be signaled via RRC signaling. The UE 115-a may benefit from having knowledge about the combination since each PDSCH may have a respective specific transport block calculation (e.g., each PDSCH may have its own modulation and coding scheme (MCS), TDRA, FDRA, and so forth). Moreover, each specific PDSCH (e.g., DCI only PDSCH, PDSCH only, or DCI Piggyback PDSCH) may be encoded via a different encoding scheme (e.g., polar or low-density parity-check (LDPC)).

In some examples, the UE 115-a may be configured to monitor both unicast DCI combined with PDSCH or unicast DCI only PDSCH, and broadcast/multicast DCI only PDSCH. In some examples, such as a 5G NR multicast-broadcast service (5G MBS), a UE 115-a may simultaneously receive up to one broadcast/multicast PDSCH and one unicast PDSCH per slot 275 (e.g., multiplexed in a time division duplexing (TDM) fashion). In some examples, multiple multicast PDSCH and multiple unicast PDSCH per slot 275 and respective configurations may be dependent on UE capability. In some examples, a UE 115-a may be capable of processing up to N different PDSCHs and a UE 115-b is configured with N+k PDSCHs, where k≥1, of different types of PDSCHs (e.g., broadcast/multicast DCI only PDSCH or unicast DCI combined with PDSCH or unicast PDSCH). In such examples, where the quantity of configured PDSCHs is greater than the capability, the UE 115-a may prioritize the PDSCHs. When a UE 115-a may be configured to monitor a combination of broadcast/multicast DCI only PDSCH and unicast DCI only PDSCH (or unicast DCI combined with PDSCH), a priority rule may be adopted such that the UE 115-a may prioritize decoding unicast PDSCHs and may drop or skip decoding the broadcast/multicast DCI only PDSCH.

In some examples, a UE 115-a may buffer the broadcast/multicast DCI only PDSCH and may decode it whenever UE 115-a is not configured with any downlink reception or uplink transmissions (i.e., decode whenever UE is available). In some examples, when the UE 115-a is in broadcast or multicast mode, the network entity 105-a may signal to the UE 115-a about the existence of the broadcast/multicast and unicast DCI PDSCHs on PDCCH. The PDSCHs are of the type either DCI only PDSCH, DCI combined with PDSCH or PDSCH (i.e., PDSCH carrying unicast and/or broadcast control information), and the setting may be different from the 5G MBS where broadcast/multicast PDSCHs carry broadcast/multicast data (e.g., TV service, streaming services, etc.).

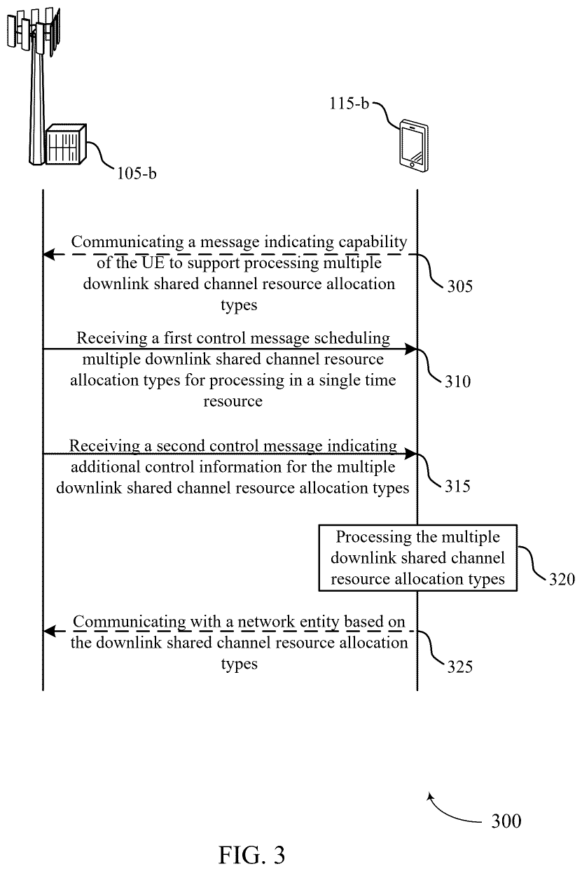

FIG. 3 shows an example of a process flow 300 that supports combined DCI and downlink shared channel communicated in a single time resource in accordance with one or more aspects of the present disclosure. The process flow 300 may implement aspects of or may be implemented by aspects of the wireless communications system 100 or the wireless communications system 200. For example, the process flow 300 may include a UE 115-b and a network entity 105-b, which may be an example of a UE 115 and a network entity 105 as described herein. In the following description of the process flow 300, the operations performed by the UE 115-b and the network entity 105-b may be performed in different orders or at different times than the exemplary order shown. Some operations may also be omitted from the process flow 300, or other operations may be added to the process flow 300. Further, while operations in the process flow 300 are illustrated as being performed by the UE 115-b and the network entity 105-b, the examples herein are not to be construed as limiting, as the described features may be associated with any quantity of different devices.

In some examples, at 305, the UE 115-b communicates a message indicating a capability of the UE 115-b to support processing of multiple downlink shared channel resource allocation types (e.g., different PDSCHs or PDSCH types, as described with reference to FIG. 2-3) in the single time resource. The UE 115-a may communicate RRC signaling including the message indicating the capability. The single time resource may include a slot.

At 310, the UE 115-b may receive a first control message scheduling multiple downlink shared channel resource allocation types for processing in a single time resource, where the multiple downlink shared channel resource allocation types include one or more of a unicast DCI carried over a downlink shared channel, unicast downlink shared channel data carried over the downlink shared channel, or unicast DCI modulated with downlink data transmissions carried over the downlink shared channel (e.g., DCI combined with PDSCH or DCI piggyback PDSCH).

At 315, the UE 115-b may receive a second control message indicating additional control information for one or more of the multiple downlink shared channel resource allocation types. The UE 115-b may receive the second control message based on the capability. The second control message includes a first format of DCI carried over a downlink control channel or a DCI component carried over one of the multiple downlink shared channel resource allocation types. The additional control information includes multiple DCI parameters corresponding to respective downlink shared channel resource allocations types, where the UE 115-b uses the multiple DCI parameters for the processing.

In some examples, in response to the multiple downlink shared channel resource allocation types exceeding the threshold quantity of different downlink shared channel resource allocation types that the UE 115-b is capable of processing within the single time resource, and the multiple downlink shared channel resource allocation types including the at least one multicast DCI, the UE 115-b may further prioritize a unicast DCI over the at least one multicast DCI for processing the multiple downlink shared channel resource allocation types. In such examples, the UE 115-b may store the at least one multicast DCI in a buffer for subsequent processing based on the prioritizing.

The UE 115-b may receive a message, prior to processing, indicating that the multiple downlink shared channel resource allocation types include the at least one multicast DCI.

At 320, the UE 115-b may process the multiple downlink shared channel resource allocation types within the single time resource. The multiple downlink shared channel resource allocation types include at least one multicast DCI, and where the UE 115-b is capable of processing the multiple downlink shared channel resource allocation types based on a threshold quantity of different downlink shared channel resource allocation types the UE 115-b is capable of processing within the single time resource.

At 325, the UE 115-b may communicate with the network entity 105-b based on the multiple downlink shared channel resource allocation types.

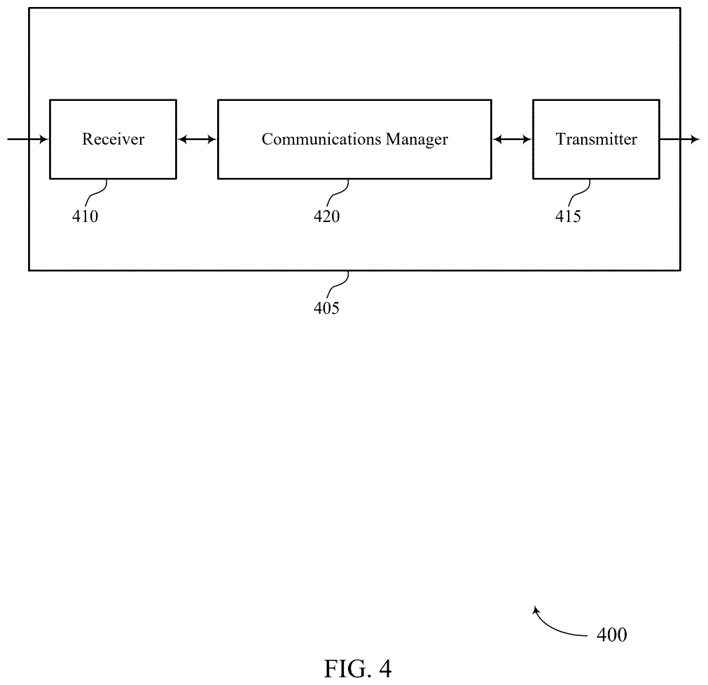

FIG. 4 shows a block diagram 400 of a device 405 that supports combined DCI and downlink shared channel communicated in a single time resource in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to combined DCI and downlink shared channel communicated in a single time resource). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to combined DCI and downlink shared channel communicated in a single time resource). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of combined DCI and downlink shared channel communicated in a single time resource as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for receiving a first control message scheduling a set of multiple downlink shared channel resource allocation types for processing in a single time resource, where the set of multiple downlink shared channel resource allocation types include one or more of unicast DCI carried over a downlink shared channel, unicast downlink shared channel data carried over the downlink shared channel, or unicast DCI modulated with downlink data transmissions carried over the downlink shared channel. The communications manager 420 is capable of, configured to, or operable to support a means for receiving a second control message indicating additional control information for one or more of the set of multiple downlink shared channel resource allocation types. The communications manager 420 is capable of, configured to, or operable to support a means for processing the set of multiple downlink shared channel resource allocation types within the single time resource. The communications manager 420 is capable of, configured to, or operable to support a means for communicating with a network entity based on the set of multiple downlink shared channel resource allocation types.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for a UE to efficiently process multiple physical downlink shared channels in a single time resource (e.g., a slot).

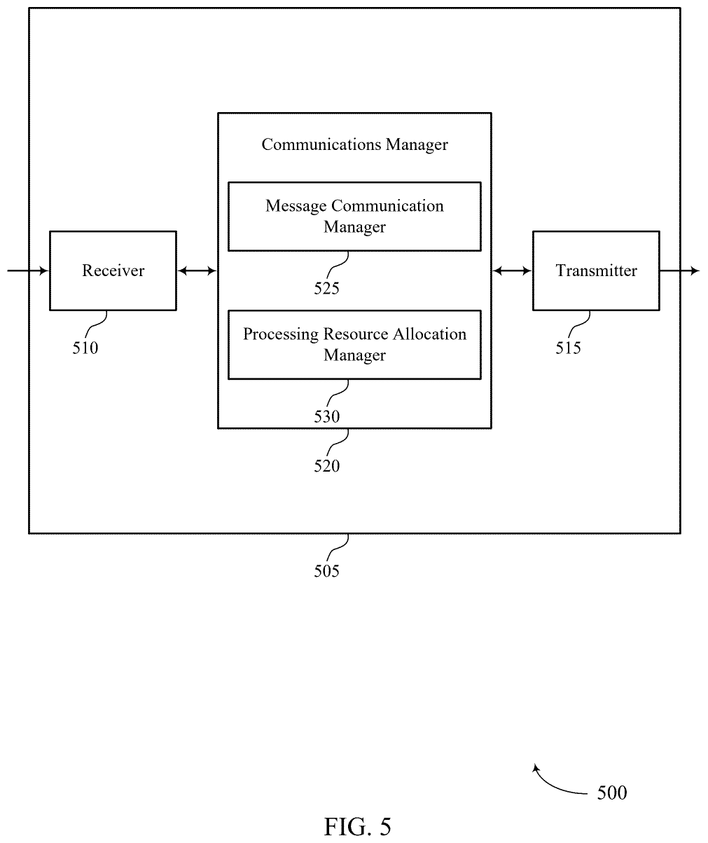

FIG. 5 shows a block diagram 500 of a device 505 that supports combined DCI and downlink shared channel communicated in a single time resource in accordance with one or more aspects of the present disclosure. The device 505 may be an example of aspects of a device 405 or a UE 115 as described herein. The device 505 may include a receiver 510, a transmitter 515, and a communications manager 520. The device 505, or one of more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to combined DCI and downlink shared channel communicated in a single time resource). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to combined DCI and downlink shared channel communicated in a single time resource). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of combined DCI and downlink shared channel communicated in a single time resource as described herein. For example, the communications manager 520 may include a message communication manager 525 a processing resource allocation manager 530, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The message communication manager 525 is capable of, configured to, or operable to support a means for receiving a first control message scheduling a set of multiple downlink shared channel resource allocation types for processing in a single time resource, where the set of multiple downlink shared channel resource allocation types include one or more of unicast DCI carried over a downlink shared channel, unicast downlink shared channel data carried over the downlink shared channel, or unicast DCI modulated with downlink data transmissions carried over the downlink shared channel. The message communication manager 525 is capable of, configured to, or operable to support a means for receiving a second control message indicating additional control information for one or more of the set of multiple downlink shared channel resource allocation types. The processing resource allocation manager 530 is capable of, configured to, or operable to support a means for processing the set of multiple downlink shared channel resource allocation types within the single time resource. The message communication manager 525 is capable of, configured to, or operable to support a means for communicating with a network entity based on the set of multiple downlink shared channel resource allocation types.

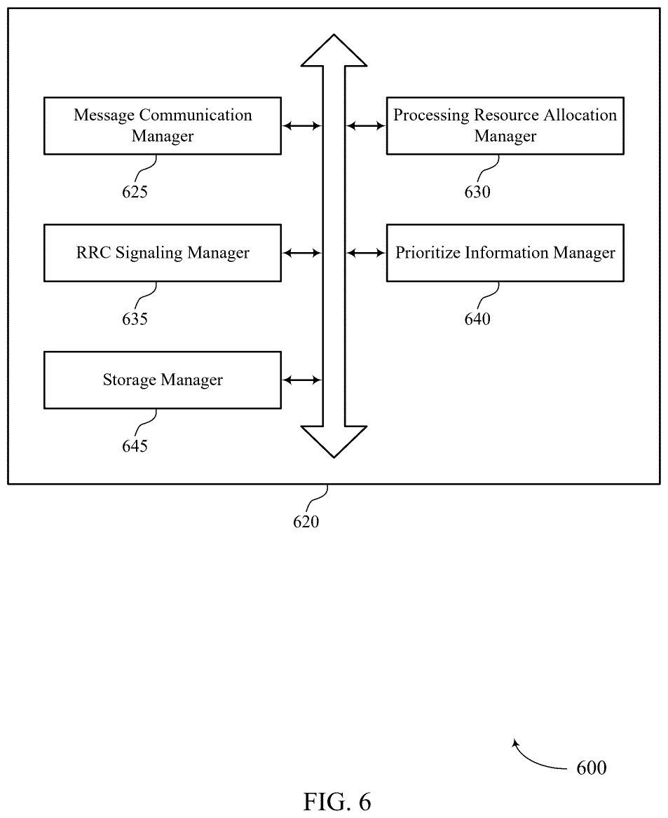

FIG. 6 shows a block diagram 600 of a communications manager 620 that supports combined DCI and downlink shared channel communicated in a single time resource in accordance with one or more aspects of the present disclosure. The communications manager 620 may be an example of aspects of a communications manager 420, a communications manager 520, or both, as described herein. The communications manager 620, or various components thereof, may be an example of means for performing various aspects of combined DCI and downlink shared channel communicated in a single time resource as described herein. For example, the communications manager 620 may include a message communication manager 625, a processing resource allocation manager 630, an RRC signaling manager 635, a prioritize information manager 640, a storage manager 645, or any combination thereof. Each of these components, or components or subcomponents thereof (e.g., one or more processors, one or more memories), may communicate, directly or indirectly, with one another (e.g., via one or more buses).

The communications manager 620 may support wireless communications in accordance with examples as disclosed herein. The message communication manager 625 is capable of, configured to, or operable to support a means for receiving a first control message scheduling a set of multiple downlink shared channel resource allocation types for processing in a single time resource, where the set of multiple downlink shared channel resource allocation types include one or more of unicast DCI carried over a downlink shared channel, unicast downlink shared channel data carried over the downlink shared channel, or unicast DCI modulated with downlink data transmissions carried over the downlink shared channel. In some examples, the message communication manager 625 is capable of, configured to, or operable to support a means for receiving a second control message indicating additional control information for one or more of the set of multiple downlink shared channel resource allocation types. The processing resource allocation manager 630 is capable of, configured to, or operable to support a means for processing the set of multiple downlink shared channel resource allocation types within the single time resource. In some examples, the message communication manager 625 is capable of, configured to, or operable to support a means for communicating with a network entity based on the set of multiple downlink shared channel resource allocation types.

In some examples, to support receiving the second control message, the message communication manager 625 is capable of, configured to, or operable to support a means for communicating a message indicating a capability of the UE to support processing of the set of multiple downlink shared channel resource allocation types in the single time resource. In some examples, to support receiving the second control message, the message communication manager 625 is capable of, configured to, or operable to support a means for receiving the second control message based on the capability.

In some examples, to support communicating the message indicating the capability, the RRC signaling manager 635 is capable of, configured to, or operable to support a means for communicating radio resource control signaling including the message indicating the capability.

In some examples, the second control message includes a first format of DCI carried over a downlink control channel or a DCI component carried over one of the set of multiple downlink shared channel resource allocation types.

In some examples, the additional control information includes a set of multiple DCI parameters corresponding to respective downlink shared channel resource allocations types. In some examples, the UE uses the set of multiple DCI parameters for the processing.

In some examples, the set of multiple downlink shared channel resource allocation types includes at least one multicast DCI. In some examples, the UE is capable of processing the set of multiple downlink shared channel resource allocation types based on a threshold quantity of different downlink shared channel resource allocation types the UE is capable of processing within the single time resource.

In some examples, the prioritize information manager 640 is capable of, configured to, or operable to support a means for prioritizing a unicast DCI over the at least one multicast DCI for processing the set of multiple downlink shared channel resource allocation types.

In some examples, the storage manager 645 is capable of, configured to, or operable to support a means for storing the at least one multicast DCI in a buffer for subsequent processing based on the prioritizing.

In some examples, the message communication manager 625 is capable of, configured to, or operable to support a means for receiving a message, prior to processing, indicating that the set of multiple downlink shared channel resource allocation types include the at least one multicast DCI.

In some examples, the single time resource includes a slot.

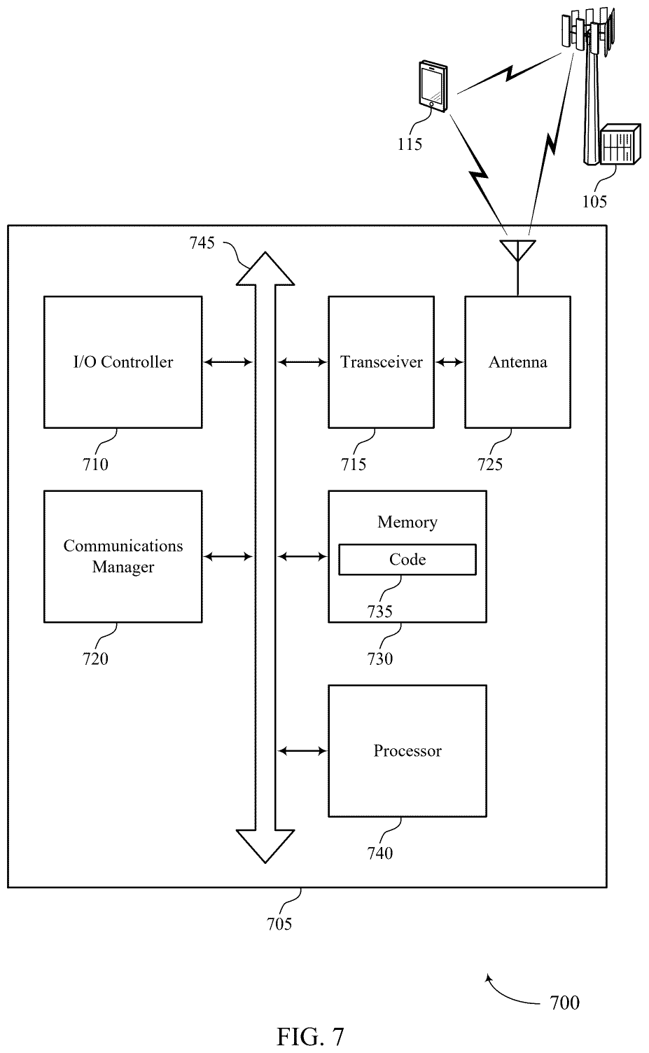

FIG. 7 shows a diagram of a system 700 including a device 705 that supports combined DCI and downlink shared channel communicated in a single time resource in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting combined DCI and downlink shared channel communicated in a single time resource). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communications in accordance with examples as disclosed herein. For example, the communications manager 720 is capable of, configured to, or operable to support a means for receiving a first control message scheduling a set of multiple downlink shared channel resource allocation types for processing in a single time resource, where the set of multiple downlink shared channel resource allocation types include one or more of unicast DCI carried over a downlink shared channel, unicast downlink shared channel data carried over the downlink shared channel, or unicast DCI modulated with downlink data transmissions carried over the downlink shared channel. The communications manager 720 is capable of, configured to, or operable to support a means for receiving a second control message indicating additional control information for one or more of the set of multiple downlink shared channel resource allocation types. The communications manager 720 is capable of, configured to, or operable to support a means for processing the set of multiple downlink shared channel resource allocation types within the single time resource. The communications manager 720 is capable of, configured to, or operable to support a means for communicating with a network entity based on the set of multiple downlink shared channel resource allocation types.

By including or configuring the communications manager 720 in accordance with examples as described herein, the device 705 may support techniques for a UE to efficiently process multiple physical downlink shared channels in a single time resource (e.g., a slot).

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of combined DCI and downlink shared channel communicated in a single time resource as described herein, or the at least one processor 740 and the at least one memory 730 may be otherwise configured to, individually or collectively, perform or support such operations.

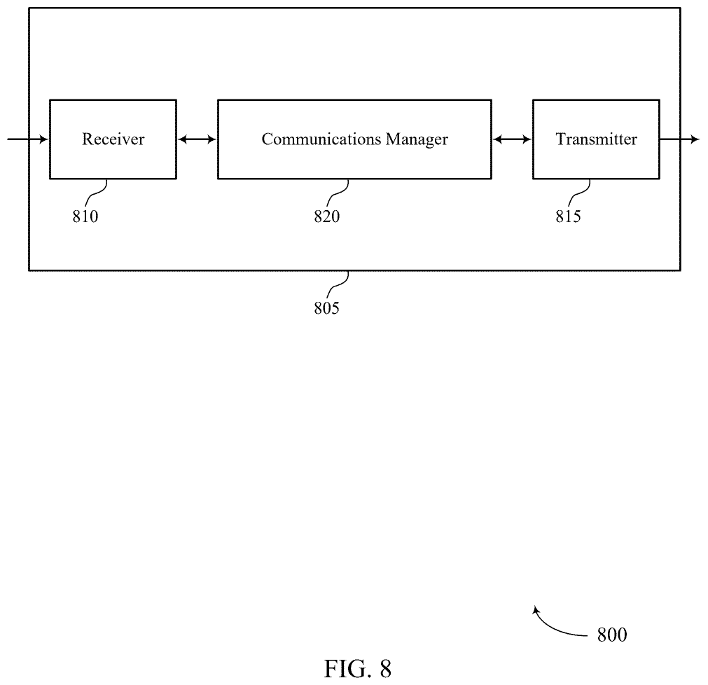

FIG. 8 shows a block diagram 800 of a device 805 that supports combined DCI and downlink shared channel communicated in a single time resource in accordance with one or more aspects of the present disclosure. The device 805 may be an example of aspects of a network entity 105 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas (such as 1115). Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations or components thereof may be examples of means for performing various aspects of combined DCI and downlink shared channel communicated in a single time resource as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for outputting a first control message scheduling a set of multiple downlink shared channel resource allocation types for processing by a UE in a single time resource, where the set of multiple downlink shared channel resource allocation types include one or more of unicast DCI carried over a downlink shared channel, unicast downlink shared channel data carried over the downlink shared channel, or unicast DCI modulated with downlink data transmissions carried over the downlink shared channel. The communications manager 820 is capable of, configured to, or operable to support a means for outputting a second control message indicating additional control information for one or more of the set of multiple downlink shared channel resource allocation types. The communications manager 820 is capable of, configured to, or operable to support a means for communicating with the UE based on the UE processing the set of multiple downlink shared channel resource allocation types within the single time resource.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for a UE to efficiently process multiple physical downlink shared channels in a single time resource (e.g., a slot).

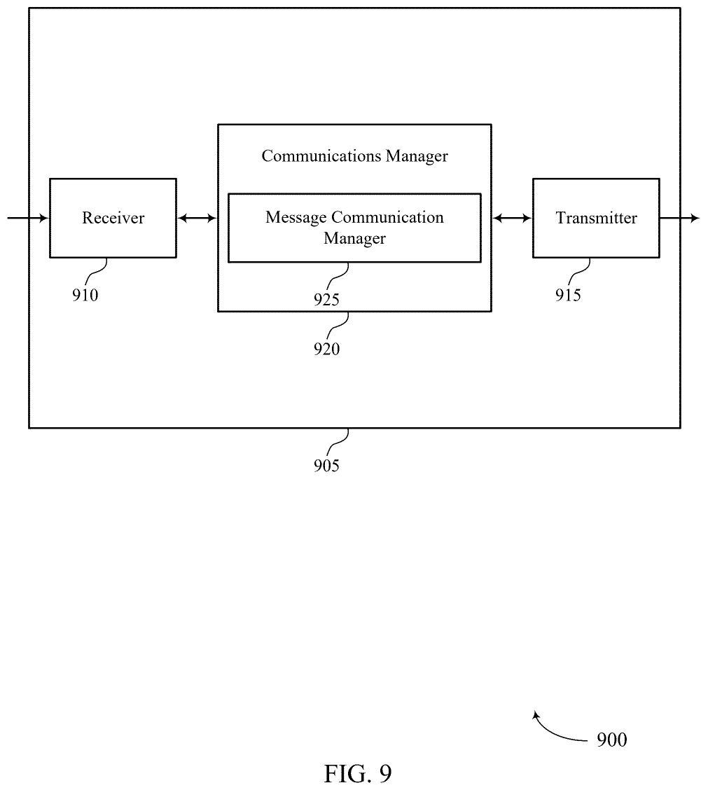

FIG. 9 shows a block diagram 900 of a device 905 that supports combined DCI and downlink shared channel communicated in a single time resource in accordance with one or more aspects of the present disclosure. The device 905 may be an example of aspects of a device 805 or a network entity 105 as described herein. The device 905 may include a receiver 910, a transmitter 915, and a communications manager 920. The device 905, or one of more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of combined DCI and downlink shared channel communicated in a single time resource as described herein. For example, the communications manager 920 may include a message communication manager 925, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The message communication manager 925 is capable of, configured to, or operable to support a means for outputting a first control message scheduling a set of multiple downlink shared channel resource allocation types for processing by a UE in a single time resource, where the set of multiple downlink shared channel resource allocation types include one or more of unicast DCI carried over a downlink shared channel, unicast downlink shared channel data carried over the downlink shared channel, or unicast DCI modulated with downlink data transmissions carried over the downlink shared channel. The message communication manager 925 is capable of, configured to, or operable to support a means for outputting a second control message indicating additional control information for one or more of the set of multiple downlink shared channel resource allocation types. The message communication manager 925 is capable of, configured to, or operable to support a means for communicating with the UE based on the UE processing the set of multiple downlink shared channel resource allocation types within the single time resource.

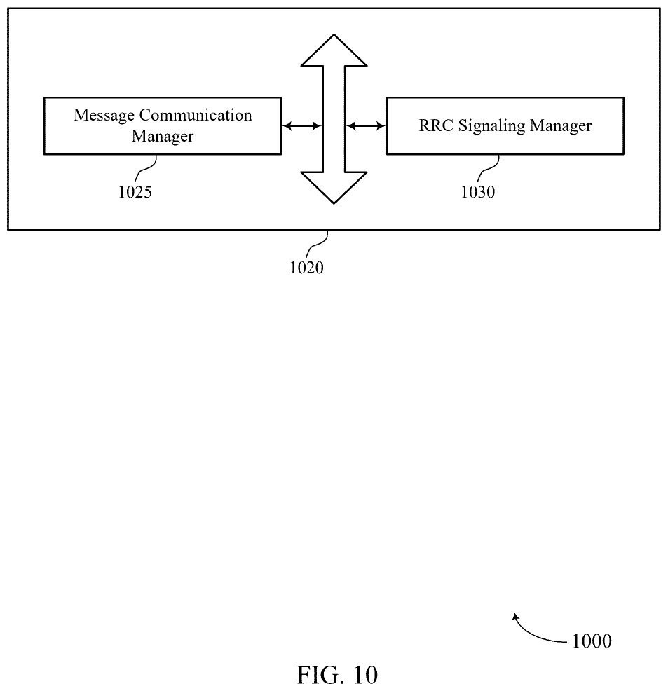

FIG. 10 shows a block diagram 1000 of a communications manager 1020 that supports combined DCI and downlink shared channel communicated in a single time resource in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of combined DCI and downlink shared channel communicated in a single time resource as described herein. For example, the communications manager 1020 may include a message communication manager 1025 an RRC signaling manager 1030, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communications in accordance with examples as disclosed herein. The message communication manager 1025 is capable of, configured to, or operable to support a means for outputting a first control message scheduling a set of multiple downlink shared channel resource allocation types for processing by a UE in a single time resource, where the set of multiple downlink shared channel resource allocation types include one or more of unicast DCI carried over a downlink shared channel, unicast downlink shared channel data carried over the downlink shared channel, or unicast DCI modulated with downlink data transmissions carried over the downlink shared channel. In some examples, the message communication manager 1025 is capable of, configured to, or operable to support a means for outputting a second control message indicating additional control information for one or more of the set of multiple downlink shared channel resource allocation types. In some examples, the message communication manager 1025 is capable of, configured to, or operable to support a means for communicating with the UE based on the UE processing the set of multiple downlink shared channel resource allocation types within the single time resource.

In some examples, to support outputting the second control message, the message communication manager 1025 is capable of, configured to, or operable to support a means for receiving a message indicating a capability of the UE to support processing of the set of multiple downlink shared channel resource allocation types in the single time resource. In some examples, to support outputting the second control message, the message communication manager 1025 is capable of, configured to, or operable to support a means for outputting the second control message based on the capability.

In some examples, to support receiving the message indicating the capability, the RRC signaling manager 1030 is capable of, configured to, or operable to support a means for receiving radio resource control signaling including the message indicating the capability.

In some examples, the second control message includes a first format of DCI carried over a downlink control channel or a DCI component carried over one of the set of multiple downlink shared channel resource allocation types.

In some examples, the additional control information includes a set of multiple DCI parameters corresponding to respective downlink shared channel resource allocations types.

In some examples, the set of multiple downlink shared channel resource allocation types includes at least one multicast DCI.

In some examples, in response to the set of multiple downlink shared channel resource allocation types exceeding a threshold quantity of different downlink shared channel resource allocation types the UE is capable of processing within a single time resource, and the set of multiple downlink shared channel resource allocation types including the at least one multicast DCI, a unicast DCI is prioritized over the at least one multicast DCI.

In some examples, the message communication manager 1025 is capable of, configured to, or operable to support a means for outputting a message, prior to the UE processing, indicating that the set of multiple downlink shared channel resource allocation types include the at least one multicast DCI.

In some examples, the single time resource includes a slot.

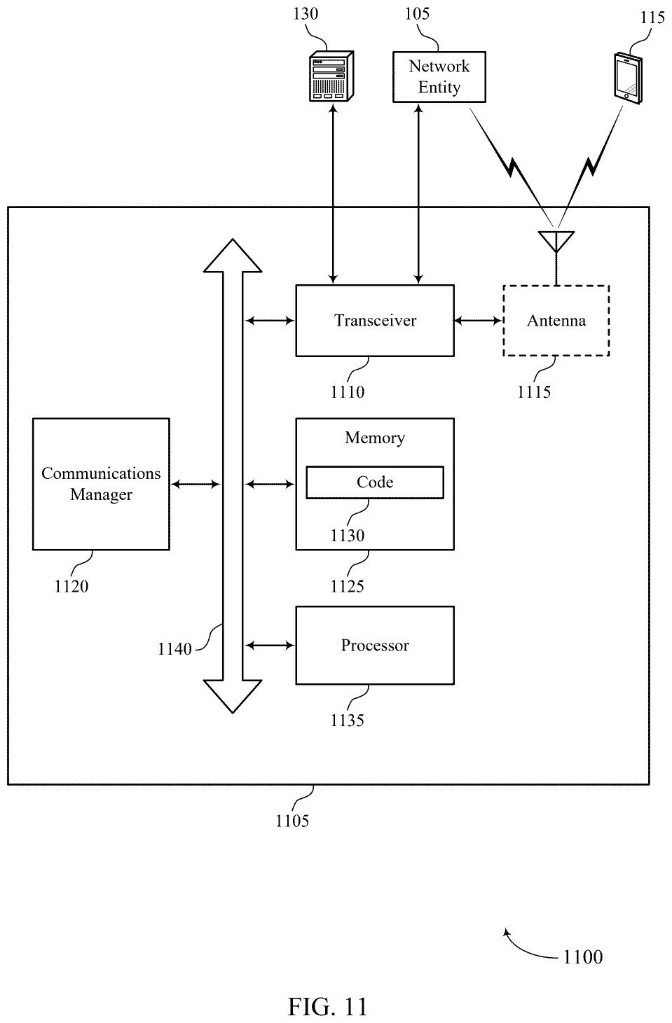

FIG. 11 shows a diagram of a system 1100 including a device 1105 that supports combined DCI and downlink shared channel communicated in a single time resource in accordance with one or more aspects of the present disclosure. The device 1105 may be an example of or include components of a device 805, a device 905, or a network entity 105 as described herein. The device 1105 may communicate with other network devices or network equipment such as one or more of the network entities 105, UEs 115, or any combination thereof. The communications may include communications over one or more wired interfaces, over one or more wireless interfaces, or any combination thereof. The device 1105 may include components that support outputting and obtaining communications, such as a communications manager 1120, a transceiver 1110, one or more antennas 1115, at least one memory 1125, code 1130, and at least one processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or one or more memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or one or more memory components (e.g., the at least one processor 1135, the at least one memory 1125, or both), may be included in a chip or chip assembly that is installed in the device 1105. In some examples, the transceiver 1110 may be operable to support communications via one or more communications links (e.g., communication link(s) 125, backhaul communication link(s) 120, a midhaul communication link 162, a fronthaul communication link 168).

The at least one memory 1125 may include RAM, ROM, or any combination thereof. The at least one memory 1125 may store computer-readable, computer-executable, or processor-executable code, such as the code 1130. The code 1130 may include instructions that, when executed by one or more of the at least one processor 1135, cause the device 1105 to perform various functions described herein. The code 1130 may be stored in a non-transitory computer-readable medium such as system memory or another type of memory. In some cases, the code 1130 may not be directly executable by a processor of the at least one processor 1135 but may cause a computer (e.g., when compiled and executed) to perform functions described herein. In some cases, the at least one memory 1125 may include, among other things, a BIOS which may control basic hardware or software operation such as the interaction with peripheral components or devices. In some examples, the at least one processor 1135 may include multiple processors and the at least one memory 1125 may include multiple memories. One or more of the multiple processors may be coupled with one or more of the multiple memories which may, individually or collectively, be configured to perform various functions herein (for example, as part of a processing system).

The at least one processor 1135 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1135 may be configured to operate a memory array using a memory controller. In some other cases, a memory controller may be integrated into one or more of the at least one processor 1135. The at least one processor 1135 may be configured to execute computer-readable instructions stored in a memory (e.g., one or more of the at least one memory 1125) to cause the device 1105 to perform various functions (e.g., functions or tasks supporting combined DCI and downlink shared channel communicated in a single time resource). For example, the device 1105 or a component of the device 1105 may include at least one processor 1135 and at least one memory 1125 coupled with one or more of the at least one processor 1135, the at least one processor 1135 and the at least one memory 1125 configured to perform various functions described herein. The at least one processor 1135 may be an example of a cloud-computing platform (e.g., one or more physical nodes and supporting software such as operating systems, virtual machines, or container instances) that may host the functions (e.g., by executing code 1130) to perform the functions of the device 1105. The at least one processor 1135 may be any one or more suitable processors capable of executing scripts or instructions of one or more software programs stored in the device 1105 (such as within one or more of the at least one memory 1125).

In some examples, the at least one processor 1135 may include multiple processors and the at least one memory 1125 may include multiple memories. One or more of the multiple processors may be coupled with one or more of the multiple memories, which may, individually or collectively, be configured to perform various functions herein. In some examples, the at least one processor 1135 may be a component of a processing system, which may refer to a system (such as a series) of machines, circuitry (including, for example, one or both of processor circuitry (which may include the at least one processor 1135) and memory circuitry (which may include the at least one memory 1125)), or components, that receives or obtains inputs and processes the inputs to produce, generate, or obtain a set of outputs. The processing system may be configured to perform one or more of the functions described herein. For example, the at least one processor 1135 or a processing system including the at least one processor 1135 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1125 or otherwise, to perform one or more of the functions described herein.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the at least one memory 1125, the code 1130, and the at least one processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with one or more other network entities 105, and may include a controller or scheduler for controlling communications with UEs 115 (e.g., in cooperation with the one or more other network devices). In some examples, the communications manager 1120 may support an X2 interface within an LTE/LTE-A wireless communications network technology to provide communication between network entities 105.

The communications manager 1120 may support wireless communications in accordance with examples as disclosed herein. For example, the communications manager 1120 is capable of, configured to, or operable to support a means for outputting a first control message scheduling a set of multiple downlink shared channel resource allocation types for processing by a UE in a single time resource, where the set of multiple downlink shared channel resource allocation types include one or more of unicast DCI carried over a downlink shared channel, unicast downlink shared channel data carried over the downlink shared channel, or unicast DCI modulated with downlink data transmissions carried over the downlink shared channel. The communications manager 1120 is capable of, configured to, or operable to support a means for outputting a second control message indicating additional control information for one or more of the set of multiple downlink shared channel resource allocation types. The communications manager 1120 is capable of, configured to, or operable to support a means for communicating with the UE based on the UE processing the set of multiple downlink shared channel resource allocation types within the single time resource.

By including or configuring the communications manager 1120 in accordance with examples as described herein, the device 1105 may support techniques for a UE to efficiently process multiple physical downlink shared channels in a single time resource (e.g., a slot).

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, one or more of the at least one processor 1135, one or more of the at least one memory 1125, the code 1130, or any combination thereof (for example, by a processing system including at least a portion of the at least one processor 1135, the at least one memory 1125, the code 1130, or any combination thereof). For example, the code 1130 may include instructions executable by one or more of the at least one processor 1135 to cause the device 1105 to perform various aspects of combined DCI and downlink shared channel communicated in a single time resource as described herein, or the at least one processor 1135 and the at least one memory 1125 may be otherwise configured to, individually or collectively, perform or support such operations.

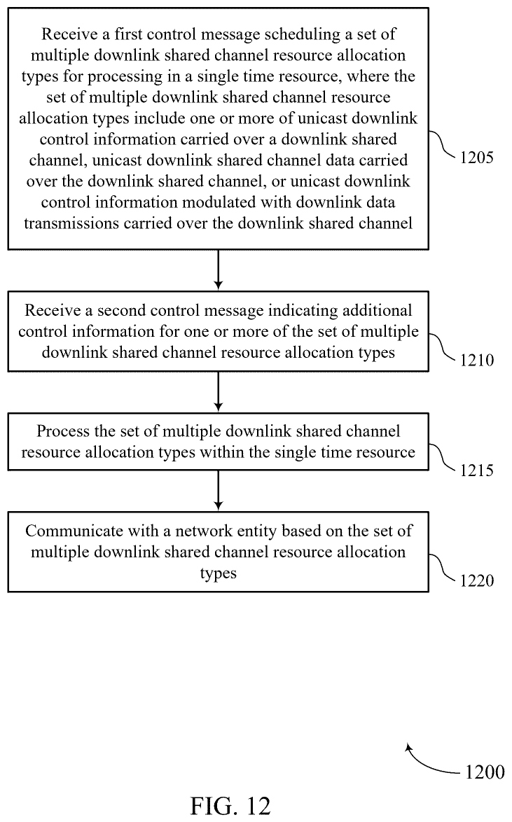

FIG. 12 shows a flowchart illustrating a method 1200 that supports combined DCI and downlink shared channel communicated in a single time resource in accordance with one or more aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include receiving a first control message scheduling a set of multiple downlink shared channel resource allocation types for processing in a single time resource, where the set of multiple downlink shared channel resource allocation types include one or more of unicast DCI carried over a downlink shared channel, unicast downlink shared channel data carried over the downlink shared channel, or unicast downlink control information modulated with downlink data transmissions carried over the downlink shared channel. The operations of 1205 may be performed in accordance with examples as disclosed herein. In some examples, aspects of the operations of 1205 may be performed by a message communication manager 625 as described herein with reference to FIG. 6.

At 1210, the method may include receiving a second control message indicating additional control information for one or more of the set of multiple downlink shared channel resource allocation types. The operations of 1210 may be performed in accordance with examples as disclosed herein. In some examples, aspects of the operations of 1210 may be performed by a message communication manager 625 as described herein with reference to FIG. 6.

At 1215, the method may include processing the set of multiple downlink shared channel resource allocation types within the single time resource. The operations of 1215 may be performed in accordance with examples as disclosed herein. In some examples, aspects of the operations of 1215 may be performed by a processing resource allocation manager 630 as described herein with reference to FIG. 6.

At 1220, the method may include communicating with a network entity based on the set of multiple downlink shared channel resource allocation types. The operations of 1220 may be performed in accordance with examples as disclosed herein. In some examples, aspects of the operations of 1220 may be performed by a message communication manager 625 as described herein with reference to FIG. 6.

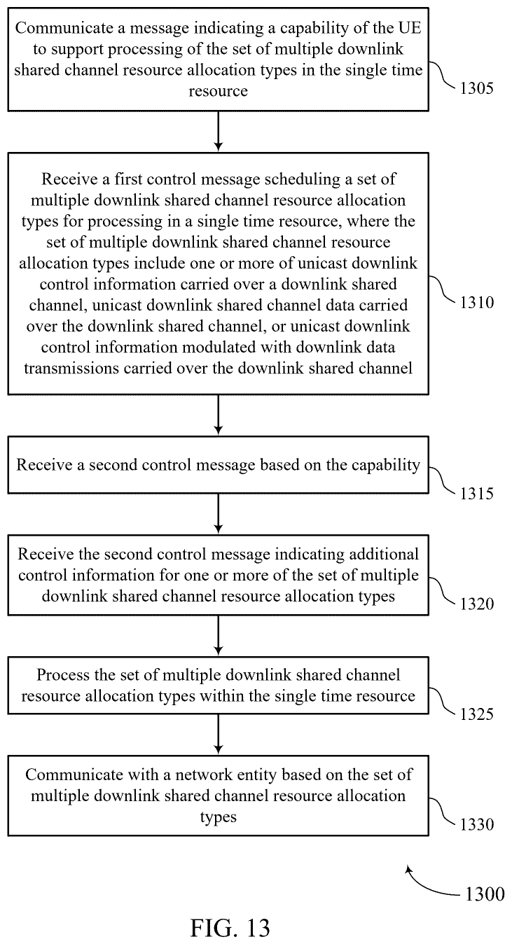

FIG. 13 shows a flowchart illustrating a method 1300 that supports combined downlink control information and downlink shared channel communicated in a single time resource in accordance with one or more aspects of the present disclosure. The operations of the method 1300 may be implemented by a UE or its components as described herein. For example, the operations of the method 1300 may be performed by a UE 115 as described herein with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1305, the method may include communicating a message indicating a capability of the UE to support processing of the set of multiple downlink shared channel resource allocation types in the single time resource. The operations of 1305 may be performed in accordance with examples as disclosed herein. In some examples, aspects of the operations of 1305 may be performed by a message communication manager 625 as described herein with reference to FIG. 6.

At 1310, the method may include receiving a first control message scheduling a set of multiple downlink shared channel resource allocation types for processing in a single time resource, where the set of multiple downlink shared channel resource allocation types include one or more of unicast downlink control information carried over a downlink shared channel, unicast downlink shared channel data carried over the downlink shared channel, or unicast downlink control information modulated with downlink data transmissions carried over the downlink shared channel. The operations of 1310 may be performed in accordance with examples as disclosed herein. In some examples, aspects of the operations of 1310 may be performed by a message communication manager 625 as described herein with reference to FIG. 6.

At 1315, the method may include receiving the second control message based on the capability. The operations of 1315 may be performed in accordance with examples as disclosed herein. In some examples, aspects of the operations of 1315 may be performed by a message communication manager 625 as described herein with reference to FIG. 6.

At 1320, the method may include receiving a second control message indicating additional control information for one or more of the set of multiple downlink shared channel resource allocation types. The operations of 1320 may be performed in accordance with examples as disclosed herein. In some examples, aspects of the operations of 1320 may be performed by a message communication manager 625 as described herein with reference to FIG. 6.

At 1325, the method may include processing the set of multiple downlink shared channel resource allocation types within the single time resource. The operations of 1325 may be performed in accordance with examples as disclosed herein. In some examples, aspects of the operations of 1325 may be performed by a processing resource allocation manager 630 as described herein with reference to FIG. 6.

At 1330, the method may include communicating with a network entity based on the set of multiple downlink shared channel resource allocation types. The operations of 1330 may be performed in accordance with examples as disclosed herein. In some examples, aspects of the operations of 1330 may be performed by a message communication manager 625 as described herein with reference to FIG. 6.

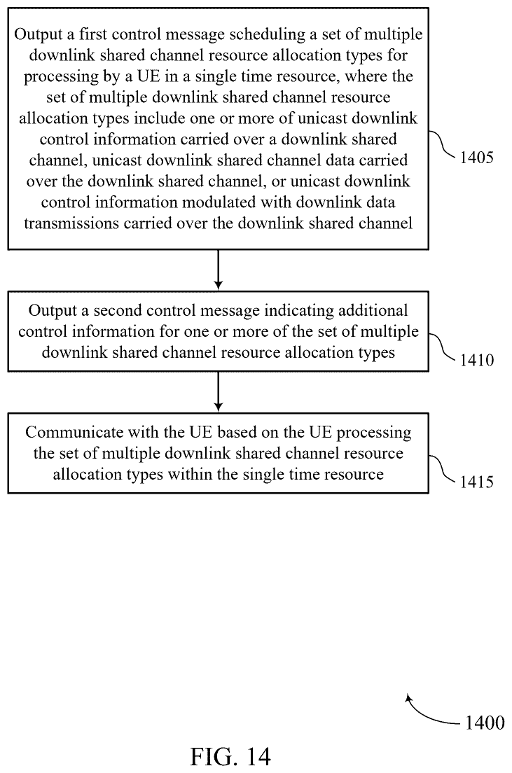

FIG. 14 shows a flowchart illustrating a method 1400 that supports combined downlink control information and downlink shared channel communicated in a single time resource in accordance with one or more aspects of the present disclosure. The operations of the method 1400 may be implemented by a network entity or its components as described herein. For example, the operations of the method 1400 may be performed by a network entity as described herein with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1405, the method may include outputting a first control message scheduling a set of multiple downlink shared channel resource allocation types for processing by a UE in a single time resource, where the set of multiple downlink shared channel resource allocation types include one or more of unicast downlink control information carried over a downlink shared channel, unicast downlink shared channel data carried over the downlink shared channel, or unicast downlink control information modulated with downlink data transmissions carried over the downlink shared channel. The operations of 1405 may be performed in accordance with examples as disclosed herein. In some examples, aspects of the operations of 1405 may be performed by a message communication manager 1025 as described herein with reference to FIG. 10.

At 1410, the method may include outputting a second control message indicating additional control information for one or more of the set of multiple downlink shared channel resource allocation types. The operations of 1410 may be performed in accordance with examples as disclosed herein. In some examples, aspects of the operations of 1410 may be performed by a message communication manager 1025 as described herein with reference to FIG. 10.

At 1415, the method may include communicating with the UE based on the UE processing the set of multiple downlink shared channel resource allocation types within the single time resource. The operations of 1415 may be performed in accordance with examples as disclosed herein. In some examples, aspects of the operations of 1415 may be performed by a message communication manager 1025 as described herein with reference to FIG. 10.

The following provides an overview of aspects of the present disclosure:

Aspect 1: A method for wireless communications at a UE, comprising: receiving a first control message scheduling a plurality of downlink shared channel resource allocation types for processing in a single time resource, wherein the plurality of downlink shared channel resource allocation types comprise one or more of unicast DCI carried over a downlink shared channel, unicast downlink shared channel data carried over the downlink shared channel, or unicast DCI modulated with downlink data transmissions carried over the downlink shared channel; receiving a second control message indicating additional control information for one or more of the plurality of downlink shared channel resource allocation types; processing the plurality of downlink shared channel resource allocation types within the single time resource; and communicating with a network entity based at least in part on the plurality of downlink shared channel resource allocation types.

Aspect 2: The method of aspect 1, wherein receiving the second control message further comprises: communicating a message indicating a capability of the UE to support processing of the plurality of downlink shared channel resource allocation types in the single time resource; and receiving the second control message based at least in part on the capability.

Aspect 3: The method of aspect 2, wherein communicating the message indicating the capability further comprises: communicating radio resource control signaling comprising the message indicating the capability.

Aspect 4: The method of any of aspects 1 through 3, wherein the second control message comprises a first format of DCI carried over a downlink control channel or a DCI component carried over one of the plurality of downlink shared channel resource allocation types.

Aspect 5: The method of any of aspects 1 through 4, wherein the additional control information comprises a plurality of DCI parameters corresponding to respective downlink shared channel resource allocations types, the UE uses the plurality of DCI parameters for the processing.

Aspect 6: The method of any of aspects 1 through 5, wherein the plurality of downlink shared channel resource allocation types comprises at least one multicast DCI, and the UE is capable of processing the plurality of downlink shared channel resource allocation types based at least in part on a threshold quantity of different downlink shared channel resource allocation types the UE is capable of processing within the single time resource.

Aspect 7: The method of aspect 6, wherein, in response to the plurality of downlink shared channel resource allocation types exceeding the threshold quantity of different downlink shared channel resource allocation types the UE is capable of processing within the single time resource, and the plurality of downlink shared channel resource allocation types comprising the at least one multicast DCI, the method further comprising: prioritizing a unicast DCI over the at least one multicast DCI for processing the plurality of downlink shared channel resource allocation types.

Aspect 8: The method of aspect 7, further comprising: storing the at least one multicast DCI in a buffer for subsequent processing based at least in part on the prioritizing.

Aspect 9: The method of any of aspects 6 through 8, further comprising: receiving a message, prior to processing, indicating that the plurality of downlink shared channel resource allocation types comprise the at least one multicast DCI.

Aspect 10: The method of any of aspects 1 through 9, wherein the single time resource comprises a slot.

Aspect 11: A method for wireless communications at a network entity, comprising: outputting a first control message scheduling a plurality of downlink shared channel resource allocation types for processing by a UE in a single time resource, wherein the plurality of downlink shared channel resource allocation types comprise one or more of unicast DCI carried over a downlink shared channel, unicast downlink shared channel data carried over the downlink shared channel, or unicast DCI modulated with downlink data transmissions carried over the downlink shared channel; outputting a second control message indicating additional control information for one or more of the plurality of downlink shared channel resource allocation types; and communicating with the UE based at least in part on the UE processing the plurality of downlink shared channel resource allocation types within the single time resource.

Aspect 12: The method of aspect 11, wherein outputting the second control message further comprises: receiving a message indicating a capability of the UE to support processing of the plurality of downlink shared channel resource allocation types in the single time resource; and outputting the second control message based at least in part on the capability.

Aspect 13: The method of aspect 12, wherein receiving the message indicating the capability further comprises: receiving radio resource control signaling comprising the message indicating the capability.

Aspect 14: The method of any of aspects 11 through 13, wherein the second control message comprises a first format of DCI carried over a downlink control channel or a DCI component carried over one of the plurality of downlink shared channel resource allocation types.

Aspect 15: The method of any of aspects 11 through 14, wherein the additional control information comprises a plurality of DCI parameters corresponding to respective downlink shared channel resource allocations types.

Aspect 16: The method of any of aspects 11 through 15, wherein the plurality of downlink shared channel resource allocation types comprises at least one multicast DCI.

Aspect 17: The method of aspect 16, wherein in response to the plurality of downlink shared channel resource allocation types exceeding a threshold quantity of different downlink shared channel resource allocation types the UE is capable of processing within a single time resource, and the plurality of downlink shared channel resource allocation types comprising the at least one multicast DCI, a unicast DCI is prioritized over the at least one multicast DCI.

Aspect 18: The method of any of aspects 16 through 17, further comprising: outputting a message, prior to the UE processing, indicating that the plurality of downlink shared channel resource allocation types comprise the at least one multicast DCI.

Aspect 19: The method of any of aspects 11 through 18, wherein the single time resource comprises a slot.

Aspect 20: A UE for wireless communications, comprising one or more memories storing processor-executable code, and one or more processors coupled with the one or more memories and individually or collectively operable to execute the code to cause the UE to perform a method of any of aspects 1 through 10.

Aspect 21: A UE for wireless communications, comprising at least one means for performing a method of any of aspects 1 through 10.

Aspect 22: A non-transitory computer-readable medium storing code for wireless communications, the code comprising instructions executable by one or more processors to perform a method of any of aspects 1 through 10.

Aspect 23: A network entity for wireless communications, comprising one or more memories storing processor-executable code, and one or more processors coupled with the one or more memories and individually or collectively operable to execute the code to cause the network entity to perform a method of any of aspects 11 through 19.

Aspect 24: A network entity for wireless communications, comprising at least one means for performing a method of any of aspects 11 through 19.

Aspect 25: A non-transitory computer-readable medium storing code for wireless communications, the code comprising instructions executable by one or more processors to perform a method of any of aspects 11 through 19.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a first control message scheduling a plurality of downlink shared channel resource allocation types for processing in a single time resource, wherein the plurality of downlink shared channel resource allocation types comprise one or more of unicast downlink control information carried over a downlink shared channel, unicast downlink shared channel data carried over the downlink shared channel, or unicast downlink control information modulated with downlink data transmissions carried over the downlink shared channel;
receive a second control message indicating additional control information for one or more of the plurality of downlink shared channel resource allocation types;
process the plurality of downlink shared channel resource allocation types within the single time resource; and
communicate with a network entity based at least in part on the plurality of downlink shared channel resource allocation types.

2. The UE of claim 1, wherein, to receive the second control message, the one or more processors are individually or collectively further operable to execute the code to cause the UE to:
communicate a message indicating a capability of the UE to support processing of the plurality of downlink shared channel resource allocation types in the single time resource; and
receive the second control message based at least in part on the capability.

3. The UE of claim 2, wherein, to communicate the message indicating the capability, the one or more processors are individually or collectively further operable to execute the code to cause the UE to:
communicate radio resource control signaling comprising the message indicating the capability.

4. The UE of claim 1, wherein the second control message comprises a first format of downlink control information carried over a downlink control channel or a downlink control information component carried over one of the plurality of downlink shared channel resource allocation types.

5. The UE of claim 1, wherein:
the additional control information comprises a plurality of downlink control information parameters corresponding to respective downlink shared channel resource allocations types; and
the UE uses the plurality of downlink control information parameters for the processing.

6. The UE of claim 1, wherein:
the plurality of downlink shared channel resource allocation types comprises at least one multicast downlink control information; and
the UE is capable of processing the plurality of downlink shared channel resource allocation types based at least in part on a threshold quantity of different downlink shared channel resource allocation types the UE is capable of processing within the single time resource.

7. The UE of claim 6, wherein, in response to the plurality of downlink shared channel resource allocation types exceeding the threshold quantity of different downlink shared channel resource allocation types the UE is capable of processing within the single time resource, and wherein the plurality of downlink shared channel resource allocation types comprises the at least one multicast downlink control information, the one or more processors are individually or collectively further operable to execute the code to cause the UE to:
prioritize a unicast downlink control information over the at least one multicast downlink control information for processing the plurality of downlink shared channel resource allocation types.

8. The UE of claim 7, wherein the one or more processors are individually or collectively further operable to execute the code to cause the UE to:
store the at least one multicast downlink control information in a buffer for subsequent processing based at least in part on the prioritizing.

9. The UE of claim 6, wherein the one or more processors are individually or collectively further operable to execute the code to cause the UE to:
receive a message, prior to processing, indicating that the plurality of downlink shared channel resource allocation types comprise the at least one multicast downlink control information.

10. The UE of claim 1, wherein the single time resource comprises a slot.

11. A network entity, comprising:
one or more memories storing processor-executable code; and
one or more processors coupled with the one or more memories and individually or collectively operable to execute the code to cause the network entity to:
output a first control message scheduling a plurality of downlink shared channel resource allocation types for processing by a user equipment (UE) in a single time resource, wherein the plurality of downlink shared channel resource allocation types comprise one or more of unicast downlink control information carried over a downlink shared channel, unicast downlink shared channel data carried over the downlink shared channel, or unicast downlink control information modulated with downlink data transmissions carried over the downlink shared channel;
output a second control message indicating additional control information for one or more of the plurality of downlink shared channel resource allocation types; and
communicate with the UE based at least in part on the UE processing the plurality of downlink shared channel resource allocation types within the single time resource.

12. The network entity of claim 11, wherein, to output the second control message, the one or more processors are individually or collectively further operable to execute the code to cause the network entity to:
receive a message indicating a capability of the UE to support processing of the plurality of downlink shared channel resource allocation types in the single time resource; and
output the second control message based at least in part on the capability.

13. The network entity of claim 12, wherein, to receive the message indicating the capability, the one or more processors are individually or collectively further operable to execute the code to cause the network entity to:
receive radio resource control signaling comprising the message indicating the capability.

14. The network entity of claim 11, wherein the second control message comprises a first format of downlink control information carried over a downlink control channel or a downlink control information component carried over one of the plurality of downlink shared channel resource allocation types.

15. The network entity of claim 11, wherein the additional control information comprises a plurality of downlink control information parameters corresponding to respective downlink shared channel resource allocations types.

16. The network entity of claim 11, wherein the plurality of downlink shared channel resource allocation types comprises at least one multicast downlink control information.

17. The network entity of claim 16, wherein, in response to the plurality of downlink shared channel resource allocation types exceeding a threshold quantity of different downlink shared channel resource allocation types the UE is capable of processing within a single time resource, and wherein the plurality of downlink shared channel resource allocation types comprises the at least one multicast downlink control information, a unicast downlink control information is prioritized over the at least one multicast downlink control information.

18. The network entity of claim 16, wherein the one or more processors are individually or collectively further operable to execute the code to cause the network entity to:
output a message, prior to the UE processing, indicating that the plurality of downlink shared channel resource allocation types comprise the at least one multicast downlink control information.

19. The network entity of claim 11, wherein the single time resource comprises a slot.

20. A method for wireless communications at a user equipment (UE), comprising:
receiving a first control message scheduling a plurality of downlink shared channel resource allocation types for processing in a single time resource, wherein the plurality of downlink shared channel resource allocation types comprise one or more of unicast downlink control information carried over a downlink shared channel, unicast downlink shared channel data carried over the downlink shared channel, or unicast downlink control information modulated with downlink data transmissions carried over the downlink shared channel;
receiving a second control message indicating additional control information for one or more of the plurality of downlink shared channel resource allocation types;
processing the plurality of downlink shared channel resource allocation types within the single time resource; and
communicating with a network entity based at least in part on the plurality of downlink shared channel resource allocation types.

21. The method of claim 20, wherein receiving the second control message further comprises:
communicating a message indicating a capability of the UE to support processing of the plurality of downlink shared channel resource allocation types in the single time resource; and
receiving the second control message based at least in part on the capability.

22. The method of claim 21, wherein communicating the message indicating the capability further comprises:
communicating radio resource control signaling comprising the message indicating the capability.

23. The method of claim 20, wherein the second control message comprises a first format of downlink control information carried over a downlink control channel or a downlink control information component carried over one of the plurality of downlink shared channel resource allocation types.

24. The method of claim 20, wherein:
the additional control information comprises a plurality of downlink control information parameters corresponding to respective downlink shared channel resource allocations types; and
the UE uses the plurality of downlink control information parameters for the processing.

25. The method of claim 20, wherein:
the plurality of downlink shared channel resource allocation types comprises at least one multicast downlink control information; and
the UE is capable of processing the plurality of downlink shared channel resource allocation types based at least in part on a threshold quantity of different downlink shared channel resource allocation types the UE is capable of processing within the single time resource.

26. The method of claim 25, wherein, in response to the plurality of downlink shared channel resource allocation types exceeding the threshold quantity of different downlink shared channel resource allocation types the UE is capable of processing within the single time resource, and wherein the plurality of downlink shared channel resource allocation types comprises the at least one multicast downlink control information, the method further comprising:
prioritizing a unicast downlink control information over the at least one multicast downlink control information for processing the plurality of downlink shared channel resource allocation types.

27. The method of claim 26, further comprising:
storing the at least one multicast downlink control information in a buffer for subsequent processing based at least in part on the prioritizing.

28. The method of claim 25, further comprising:
receiving a message, prior to processing, indicating that the plurality of downlink shared channel resource allocation types comprise the at least one multicast downlink control information.

29. The method of claim 20, wherein the single time resource comprises a slot.

30. A method for wireless communications at a network entity, comprising:
outputting a first control message scheduling a plurality of downlink shared channel resource allocation types for processing by a user equipment (UE) in a single time resource, wherein the plurality of downlink shared channel resource allocation types comprise one or more of unicast downlink control information carried over a downlink shared channel, unicast downlink shared channel data carried over the downlink shared channel, or unicast downlink control information modulated with downlink data transmissions carried over the downlink shared channel;
outputting a second control message indicating additional control information for one or more of the plurality of downlink shared channel resource allocation types; and
communicating with the UE based at least in part on the UE processing the plurality of downlink shared channel resource allocation types within the single time resource.
